(19) United States
(12) Patent Application Publication
(10) Pub. No.: US 2019/0394289 A1
(43) Pub. Date: Dec. 26, 2019

(54) TECHNIQUES FOR PROACTIVE REMINDERS

(71) Applicant: Apple Inc., Cupertino, CA (US)

(72) Inventors: Matthew Ross Lehrian, Pittsburgh, PA (US); Zachariah N. Paine, Pittsburgh, PA (US); Evan S. DiBiase, Pittsburgh, PA (US)

(73) Assignee: Apple Inc., Cupertino, CA (US)

(21) Appl. No.: 16/015,076

(22) Filed: Jun. 21, 2018

(51) Int. Cl. H04L 29/08; H04W 4/02; G06Q 10/10

(52) U.S. Cl. CPC H04L 67/26; H04W 4/02; G06Q 10/1095; H04L 67/10; H04L 67/22; H04L 67/322

(57) ABSTRACT

Embodiments of the present disclosure are directed to, among other things, improving data security with respect to data collection, verification, and authentication techniques associated with obtaining and transmitting identity information. For example, an identification credential may be received (e.g., via a short-range communications protocol such as iBeacon) by a first device from a second device. The credential may be associated with a second user of the second device. The first device may verify the credential and, if valid, an additional option to approve a secure communications channel may be presented at the first device. If the additional option is selected, a secure communications channel may be established between the first device and the second device.

### BACKGROUND

In today's electronically driven world, users often utilize reminders (e.g., alarms, alerts, notifications, badges, etc.) to remind them to perform various activities (e.g., pick up milk, buy plane tickets, etc.). Currently, such reminders have limited functionality. For example, a user may be able to access user interfaces for providing information about a task. The user can typically set a time to be reminded of the task (e.g., 10 minutes before the time associated with the task, 1 day before the time associated with the task, etc.). However, this requires the user to prognosticate when it may be best to receive the reminder. If the reminder is provided at an inopportune time, or the user forgets to configure a reminder, the task may not be completed. Improvements are needed with respect to the configuration of tasks and reminder mechanisms associated with such tasks.

### BRIEF SUMMARY OF THE INVENTION

Embodiments of the present disclosure can provide systems, methods, and computer-readable medium for improving configuration aspects and reminders related to tasks associated with a user.

In some embodiments, a computer-implemented method is disclosed. The method may comprise receiving, from a first user, task information that identifies a task to be performed, the task information including parameters for performance of the task. The method may further comprise receiving delegation information that identifies a second user capable of performing the task on behalf of the first user. The method may further comprise identifying first location information of the first user. The method may further comprise calculating a first relevance score for performance of the task by the first user based at least in part on first location information of the first user. The method may further comprise receiving, from a social media platform, a social media post made by the second user. The method may further comprise analyzing the social media post to identify second location information of the second user. The method may further comprise calculating a second relevance score for performance of the task by the second user based at least in part on the second location information of the second user. The method may further comprise determining, based at least in part on first relevance score and the second relevance score, whether to provide a notification about the task to the first user or the second user. The method may further comprise providing the notification about the task to one of the first user or the second user based at least in part on the determination.

In some embodiments, an electronic device is disclosed. The electronic device may comprise a memory and one or more processors in communication with the memory, the one or more processors being configured to perform operations. The operations may include receiving, from a first user, task information that identifies a task to be performed, the task information including parameters for performance of the task. The operations may further comprise determining delegation information that identifies a plurality of users capable of performing the task on behalf of the first user. The operations may further comprise obtaining, from a social media platform, respective social media posts made by a set of users of the plurality of users capable of performing the task on behalf of the first user. The operations may further comprise analyzing the respective social media posts to identify respective location information for each of the set of users. The operations may further comprise calculating a set of relevance score for performance of the task by the set of users based at least in part on the respective location information of the set of users. The operations may further comprise determining, based at least in part on respective relevance scores, a particular user to provide a notification about the task. The operations may further comprise providing the notification about the task to the particular user based at least in part on the determination.

In some embodiments, a computer-readable storage medium is disclosed. The computer-readable storage medium may have stored thereon computer-executable instructions that, when executed by one or more processors, configure the one or more processors to perform operations. The operations may include receiving, from a first user, task information that identifies a task to be performed, the task information including parameters for performance of the task. The operations may further include receiving delegation information that identifies a second user capable of performing the task on behalf of the first user. The operations may further include identifying first location information of the first user. The operations may further include calculating a first relevance score for performance of the task by the first user based at least in part on first location information of the first user. The operations may further include receiving, from a social media platform, a social media post made by the second user. The operations may further include analyzing the social media post to identify second location information of the second user. The operations may further include calculating a second relevance score for performance of the task by the second user based at least in part on the second location information of the first user. The operations may further include determining, based at least in part on first relevance score and the second relevance score, whether to provide a notification about the task to the first user or the second user. The operations may further include providing the notification about the task to one of the first user or the second user based at least in part on the determination.

### BRIEF DESCRIPTION OF THE DRAWINGS

Various embodiments in accordance with the present disclosure will be described with reference to the drawings, in which:

FIG. 1 illustrates an example environment for providing proactive reminders utilizing a proactive reminders engine, in accordance with at least one embodiment;

FIG. 2 illustrates an example user interface for configuring a reminder, in accordance with at least one embodiment;

FIG. 3 is an example flow for implementing task delegation techniques, in accordance with at least one embodiment;

FIG. 4 is another example flow for implementing task delegation techniques, in accordance with at least one embodiment;

FIG. 5 is an example architecture for a system for providing a proactive reminders utilizing a proactive reminders engine, in accordance with at least one embodiment;

FIG. 6 illustrates in greater detail the components of an example proactive reminders engine, in accordance with at least one embodiment;

FIG. 7 is a flowchart illustrating an example method for implementing aspects of task delegation, in accordance with at least one embodiment; and

FIG. 8 is a flowchart illustrating another example method for implementing aspects of task delegation, in accordance with at least one embodiment.

### DETAILED DESCRIPTION OF THE INVENTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Embodiments of the present disclosure are directed to, among other things, improving configuration aspects and reminders delivery with respect to tasks associated with a user. As used herein, a “task” may include any suitable activity to be performed by a user. Additionally, “reminders” may include any suitable electronic delivery mechanism in any suitable form (e.g., alarms, alerts, emails, push notifications, badges, etc.). The examples and contexts of such examples provided herein are intended for illustrative purposes and not to limit the scope of this disclosure.

In some embodiments, a user may access a user interface at an electronic device (e.g., the user's device such as a smartphone, laptop, or the like). The user interface may provide various configuration options for initializing and/or configuring a task. By way of example, a task may be initialized that details an activity such as “buy milk.” Within the user interface, various reminder options may be provided that enable a reminder to be associated with the task. For example, an option to provide a reminder at a particular time (e.g., 2 hours before a time associated with the task) or at a particular location (e.g., at the user's home) may be selected. While the user may be provided means to configure these reminders to some extent, a proactive reminders engine may be utilized to optimize configuration of such reminders, even when a reminder has not been manually configured (and in some cases even when the user has not manually initiated a task).

As a non-limiting example, a user may utilize a user interface provided as part of an application operating on his electronic device (e.g., a smartphone). Within the user interface, the user may provide task information (e.g., a title for the task such as “Buy milk”). Additional task information (e.g., a description, a date and/or a time assigned to the task, a priority, reminder information (e.g., a type of reminder, a time and/or a location associated with the reminder), a task category, additional notes associated with the task, or the like) may be optionally provided at the user interface. The task information may be stored at the device and/or may be provided to a server computer for storage. Should a server computer be utilized, the server computer may be configured to provide backend processing for storing tasks and providing, at the user's device, proactive reminders and/or notifications associated with the task(s). As used herein, a “proactive reminder” is intended to refer to the presentation of information in any suitable form for a task for which the recipient was previously aware (e.g., as when a user has manually initiated the task himself). A “notification” may relate to information regarding a task for which the recipient was previously unaware (e.g., as when a delegation candidate receives information that indicates a request to perform a task on behalf of another user, when a task was generated via means that did not include the user manually initiating the task, etc.). Delegation candidates will be discussed in more detail in the following paragraphs. It should be appreciated that any of the following functionality may be provided by the electronic device itself, by a server computer in communication with the electronic device, or any suitable combination of the two.

Once a task has been created at the user interface, a proactive reminders engine (e.g., operating at the electronic device or at a server computer in communication with the electronic device) may obtain a variety of information from which determinations related to when and how a proactive reminder (and/or notification) related to the task may be provided. By way of example, the proactive reminders engine may gather any suitable combination of crowdsourced activity data, historical user activity data, location data, social media data, and/or planned activity data.

In some embodiments, crowdsourced activity data may include information related to a group of users and their associated tasks, reminders, notifications, locations, and activities, at least a portion of which may have occurred in the past. By way of example, crowdsourced activity data may indicate that users perform certain activities most often when particular stimuli are involved. For example, crowdsourced activity data may indicate that users purchase milk most often during their commute home. This indication may be determined from determining from the crowdsourced activity data that some number of users (e.g., over a threshold amount) initiated a task (e.g., buy milk), traveled along a particular path during a particular time of day on particular days of the week and eventually ended at a particular location (e.g., a location associated with their residence), that a particular location was visited (e.g., associated with a grocery store), and that the task was deleted (or otherwise acknowledged) either while the user was at the particular location and/or soon thereafter (e.g., within a threshold time of visiting the location). Crowdsourced activity data can include any suitable information such as location information of a group of users, scheduling information (e.g., calendar entries), social media information associated with each of the group of users, task creation and deletion activities of the group of users, or any suitable information from which past task performance can be inferred.

Historical user activity data may include similar types of data as the crowdsourced activity data, but historical user activity data may be associated with a particular user (e.g., the user of the electronic device). As used herein, historical user activity data may include any suitable combination of information in any suitable form from which task performance activities of the particular user can be inferred with respect to information about activities that have occurred in the past. As a specific example, historical user activity data may indicate that the particular user typically buys milk on Wednesdays at 5:30 PM, that he typically purchases milk from a particular location, that when he has a meeting on a Wednesday at 5:00 he has typically purchased milk later in the week (e.g., the next day, in this case, a Thursday), etc. Task performance may be inferred from any suitable historical user activity data. In some embodiments, the historical user activity data may further indicate that this particular user most often completes a task when certain stimuli are provided. For example, a particular user may perform a task more reliably when a push notification is provided with an audible alert. Whereas, the user may less often perform the task if only a push notification is provided.

Location data (sometimes referred to as location information) may indicate real-time locations of one or more users. By way of example, location data may indicate that a particular user is currently located at a particular address. The location data may be associated with a place of business or an area/establishment that is associated with the particular user. Generally, location data may be utilized to determine specifically where a user may be located. As a non-limiting example, a global positioning system (GPS) in communication with the user's electronic device may determine GPS coordinates associated with the area at which the electronic device is located.

Social media data may be associated with one or more users (e.g., the user, other users, etc.). Social media data may include any suitable combination of social media posts, images, locations associated with posts, associations with social media events advertised on a social media platform, the user's “friends” or contacts within a social media platform, social media pages associated with a user, or the like.

Planned activity data may include any suitable scheduling information such as calendar events, other tasks, etc. which may indicate the user's future activities. Planned activity data may be associated with the user and/or another user(s). By way of example, planned activity data may include a user has a scheduled meeting to talk with “Tom” on a particular day, at a particular time, and perhaps at a particular location.

In some embodiments, the proactive reminders engine may utilize any suitable combination of crowdsourced activity data, historical user activity data, location data, social media data, and/or planned activity data (e.g., collectively referred to as “deterministic data”) to determine if a task reminder is to be provided and the manner in which it is provided. Returning to the example in which a user initiates a task to “buy milk,” the proactive reminders engine may independently (without further user input) determine from any suitable combination of the deterministic data that 1) a reminder is to be provided and 2) the reminder should be provided as a push notification to the user at a particular time, at a particular location, and/or upon a set of conditions being met. As a non-limiting example, the user may initiate a task (or as discussed later herein, a task may be automatically generated from other data such as a text message) that the user is to “talk to Tom about Vegas.” It may be the case, that the user has a meeting scheduled with a “Tom Smith” at 4 PM the next day. Accordingly, the user may be provided a proactive reminder some time before the meeting (e.g., at 3:45) even though the user did not specifically request or configure a reminder. In the same vein, if a task is initiated to “talk to Tom about Vegas,” and deterministic data (e.g., location data) indicates that “Tom Smith” is likely the “Tom” being referred to, and that “Tom Smith” is likely nearby at approximately 2 PM, a proactive reminder may be suppressed given that a meeting is scheduled with Tom at 4 PM. Alternatively, if there were no meeting scheduled, a proactive reminder may be provided the user when “Tom” (or Tom's device) appears to be approaching the user's device.

In some embodiments, the proactive reminders engine may be configured to determine another user who may be selected to perform the task on behalf of the user who initiated the task (or for whom the task was initiated). In some embodiments, the user may manually provide delegation information. Delegation information may include identities (e.g., names, screen names, phone numbers, etc.) of another person or people who may be considered for performing the task on behalf of the user. Additionally, or alternatively, delegation information may be identified by the proactive reminders engine without requiring the user to submit such information manually. By way of example, past delegates associated with historically performed tasks associated with the user, social media friends, family members, neighbors, and the like may be identified by analyzing any suitable portion of deterministic data such as, social media data, planned activity data, historical user activity data, and the like.

Utilizing any suitable combination of the information described above, the proactive reminders engine may be configured to identify a particular user for performing the task and may provide a reminder (e.g., a notification in any suitable form) to that user at a time and in a manner that provides the highest likelihood of task completion. Thus, a user need not attempt to prognosticate when he might be interested in receiving reminders. Rather, the proactive reminders engine can automatically configure and provider reminders in a manner that optimizes the likelihood that the task will be completed (either by the user themselves or by someone else on behalf of the user). This alleviates the burden on the user with respect to configuring various reminders which may, in the end, fail to provide information at a time and in a manner that is most beneficial for that particular user.

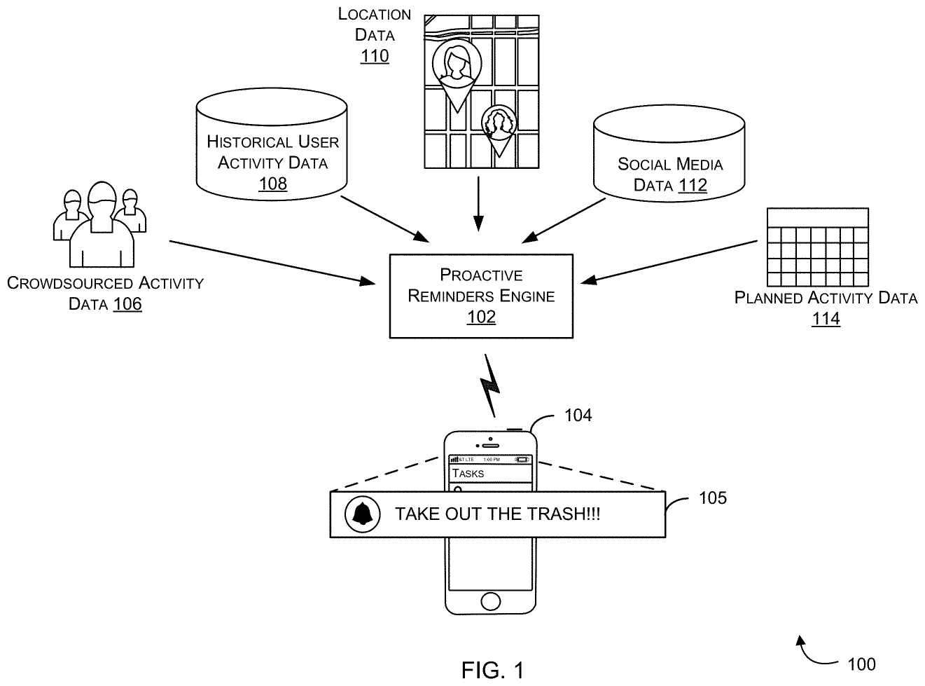

Such concepts will be discussed further below with respect to at least FIGS. 1-8.

FIG. 1 illustrates an example environment 100 for providing proactive reminders utilizing a proactive reminders engine 102, in accordance with at least one embodiment. The proactive reminders engine 102 may operate as part of, or separate from, an application operating on the user device 104.

As discussed above, the user may initiate a task at the user device 104. The user may initiate this task from any location at any time. For purpose of illustration, the task may be entitled “take out the trash!!!” In some examples, the user may, or may not, have configured a reminder 105 for the task. The proactive reminders engine 102 may be configured to receive/obtain and store task information (e.g., the title, description, date associated with the task, etc.) at any suitable location accessible to the proactive reminders engine 102. The proactive reminders engine 102 may utilize previously-stored and/or relatively recently-obtained deterministic data including any suitable combination of deterministic data (e.g., the crowdsourced activity data 106, the historical user activity data 108, the location data 110, the social media data 112, and/or the planned activity data). In some embodiments, the proactive reminders engine 102 may request such data from other data sources (e.g., other applications, an operating system of the user device 104, server computers associated with a variety of applications and/or websites, etc.). In some embodiments, deterministic data may be obtained in any suitable manner and stored in a data store accessible to the proactive reminders engine 102.

The proactive reminders engine 102, may determine a timing window within which reminder 105 is to be provided. In some cases, a deadline may be determined such that a reminder 105 is to be provided by a certain day/time, although the particular day/time for delivery of the reminder 105 may be initially unknown. Through an analysis of the deterministic data described above (e.g., perhaps utilizing supervised and/or unsupervised machine learning techniques), the proactive reminders engine 102 may determine that the user's trash is typically collected on Fridays. This information may be identified, for example, by determining that the user has initiated past tasks that are similar to taking out the trash. In examples provided herein, the proactive reminders engine 102 may utilize any suitable method for determining whether two tasks are similar. For example, a trained machine learning model may be utilized that obtains task information as input and provides a classification (e.g., task category) with which other tasks having the same classification may be identified. Similar tasks may be additionally or alternatively determined by comparing two tasks and calculating a similarity score. A similarity score over a threshold value may indicate that the tasks are relatively likely to be tasks that are associated with a same or similar activity. In some examples, the user may categorize the task with a task category and other tasks with similar task categories may be identified. Any suitable method for determining a degree of similarity between two tasks may be utilized and would be known by one skilled in the art.

As another example of information that may be considered when determining a timing window and/or deadline, the proactive reminders engine 102 may utilize deterministic data (and perhaps supervised and/or unsupervised machine learning techniques) to determine that users located nearby (e.g., within some threshold distance of the user and/or the user's home) have initiated and/or performs tasks related to taking out the trash (or similar tasks such as tasks related to garbage collection, recycling, etc.) on Fridays. The proactive reminders engine 102 may determine that the user has typically deleted past related tasks on Fridays. From this information (and perhaps a determination that users typically delete tasks on the day that they are performed), the proactive reminders engine 102 can infer the user's garbage day most likely occurs on Fridays.

The proactive reminders engine 102 may utilize predetermined rules (and/or supervised and/or unsupervised machine learning techniques) and deterministic data to determine a timing window and/or a deadline for the task. For example, a predetermined rule may specify that a reminder for a task is not to be provided more than five days before the task window expires/the deadlines occurs, or within 2 hours of a time associated with the task, etc. The predetermined rule may vary based at least in part on the type of task (e.g., a task category, a topic associated with the task, etc.), a complexity of the task, an importance or priority associated with the task, and the like. In some examples, the proactive reminders engine 102 may analyze deterministic data to identify instances in which reminders were provided that do not appear to have stimulated task performance as well as reminders for which supporting information (e.g., some portion of the deterministic data) indicates that the task associated with the reminders was performed. Utilizing this information, the proactive reminders engine 102 can determine an optimal timing window within which (or a deadline by which) the reminder may be provided to ensure the greatest likelihood that the reminder stimulates actual performance of the task.

Once a timing window and/or deadline for a task is determined (either from task information provided by the user or by analyzing deterministic data as described above), the proactive reminders engine 102 may actively seek opportunities at which to provide the reminder 105. For example, the proactive reminders engine 102 may determine from deterministic data (e.g., location data, historical user activity data, planned activity data, etc.) that the user is typically at a particular location (e.g., his home) when similar tasks were completed, that other users are typically at locations associated with their respective residences when similar tasks were completed, that the user and/or users typically completes similar tasks at a certain time of day (e.g., around 8 PM, after dusk, before leaving for work, etc.), or the like. Utilizing this information, the proactive reminders engine 102 may further analyze the deterministic data to determine a likelihood that a task would be completed if reminder 105 was provided at a particular time, given the particular circumstances and/or context indicated by at least some portion of the deterministic data.

As just one example, a user may arrive at his home after work at around 6:00 PM. The proactive reminders engine 102 may determine that reminder 105 is to be provided to the user as a result of determining a task that is associated with the user has a timing window and/or deadline within which the current day/time applies. For example, the task associated with taking out the trash may have a deadline occurring in eight hours. Given that this user and/or other users typically go to bed at 10:00 PM for example, the proactive reminders engine 102 may determine that the reminder 105 should be provided to the user sometime after the user arrives home, but before 10:00 PM. The proactive reminders engine 102 may further determine (e.g., based at least in part on analyzing deterministic data) that the user should not be provided reminder 105 within some time period of arriving at the location (e.g., within 30 minutes of arriving home). Subsequently, the proactive reminders engine 102 may determine that the user has been home for approximately an hour, that the user is actively engaged with his phone, that the deadline for the task occurs in seven hours, and the user's estimated wake time occurs in nine hours, or any suitable contextual or situational information known or inferred from the deterministic data. Given such information, the proactive reminders engine 102 may be configured to provide reminder 105 (e.g., a push notification) to the user's smartphone. If the user was not actively utilizing his phone, the proactive reminders engine 102 may determine that the reminder 105 should be provided as a push notification with an audible alert, or that the reminder 105 should be provided an audible command (e.g., “Don't forget to take out the trash!”) and/or an alarm should sound on the phone to attract the user's attention.

In another example, the user may decide to go out to dinner with friends the night before his trash is to be collected. The proactive reminders engine 102 may determine (e.g., via at least location data of the deterministic data) that the user has not arrived home. If the user was to stay out and return home close to an estimated bed time, the proactive reminders engine 102 may be configured to provide the reminder 105 as the user arrives home, rather than waiting to provide the reminder after the user has been home for period of time (e.g., an hour, two hours, etc.). Thus, the proactive reminders engine 102 may adjust the manner in which it provides proactive reminders to the user based at least in part on the context and/or situation indicated by the location of the user, the user's historical activity data, crowdsourced activity data, or any suitable combination of any portion of the deterministic data discussed herein.

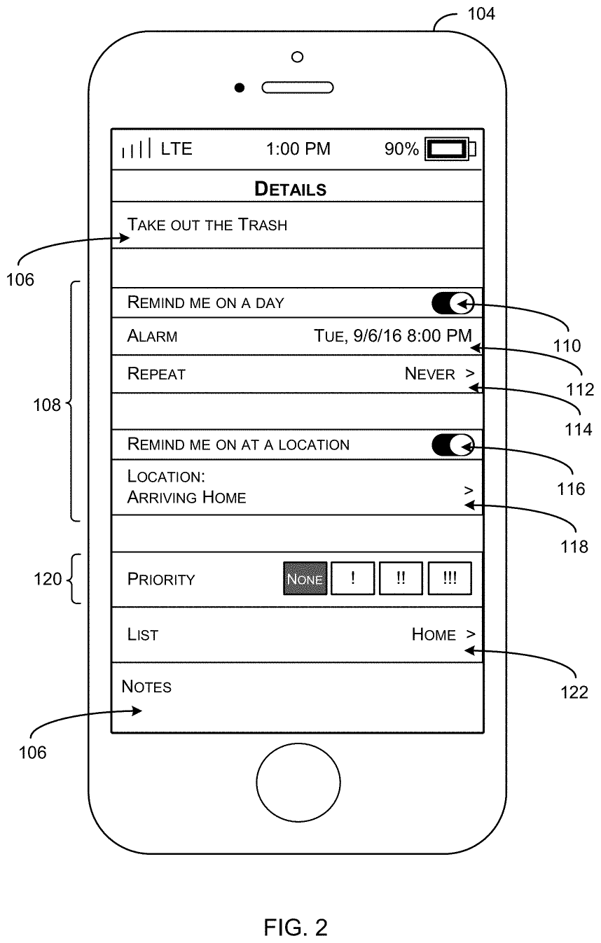

FIG. 2 illustrates an example user interface 200 for configuring a (traditional) reminder, in accordance with at least one embodiment. It should be appreciated that the user interface 200 may include the various user interface elements discussed herein, or the specific user interface elements may differ. By way of example, the user interface 200 may be provided as part of a reminder-based application within which tasks may be initiated. In some embodiments, the user may initiate a task by vocal input, through a texting application, a calendar application, or the like. As a simplistic example, a task may be initiated based on the user sending a text message to his wife that states, among other things, that he needs to “pick up milk.” In this example, the text message may be initiated by the user, or by his wife.

Returning to the example depicted in FIG. 2, the user interface 200 may be provided on the user device 104 (or any suitable electronic device). The user interface 200 may include user interface elements 206 which may be utilized to provide a title and/or description of a task (e.g., “take out the trash”). In some embodiments, the user interface 200 may include any suitable combination of user interface elements 206 related to configuring a reminder for the task.

By way of example, the user interface 200 may include user interface elements 206, 208, and/or 210 for configuring a reminder for the task on a particular day. The option for configuring the reminder for a particular day may be selected utilizing user interface element 210. An alarm and/or the day/time for the reminder may be configured using user interface element 212. In some embodiments, the user interface element 214 may be utilized to configured repetitive reminders. For example, the user may configured reminders to occur every Wednesday, weekly, monthly, yearly, etc.

In some embodiments, the user interface 200 may provide an option for configuring a reminder based at least in part on a particular location. The option for configuring the reminder for a particular location may be selected utilizing user interface element 216. In some examples, the location may be specified using user interface element 218.

The user interface 200 may further include priority assignment options 120. The priority assignment options may include any suitable number and/or type of user interface elements (e.g., buttons, checkboxes, text/edit boxes, radio buttons, etc.) to enable a priority for the task to be selected.

The user interface 200 may further enable the user to select a list and/or categorize the task utilizing user interface element 222. The user interface element may also include any suitable type of user interface element(s) such as buttons, checkboxes, text/edit boxes, radio buttons, etc. to provide such functionality.

The user interface 200 may further include user interface element 224 which may be any suitable type of user interface element that is configured to receive text, images, audio, or the like with which the task is associated. Accordingly, a user may utilize user interface element 224 to provide notes associated with the task (e.g., “the garbage truck arrives at 5 AM”).

It should be appreciated that the user interface 200 is merely one example of a user interface that may utilized with the proactive reminders engine 102 of FIG. 1. It is not intended to limit the scope of the disclosure or imply that other interfaces/interface elements may not be used. As discussed above, there may be a variety of means for a user to generate a task and/or provide task information. Although the particular user interface elements of FIG. 2 allow for certain information to be provided and/or certain features of a reminder to be configured, it is not necessarily the case in every scenario. As discussed above, the user may generate a task in various ways including, but not limited to, providing a vocal command (e.g., “phone, remind me to take out the trash”), creating a scheduled event (e.g., via a calendar or other scheduling application/website), transmitting or receiving a text message with particular content, generating a list within an application (e.g., a grocery store list application, a notepad-type application operating on the user's device, etc.), etc. Although potentially not depicted, the user interface 200 may be utilized to obtain any suitable combination of user input discussed herein.

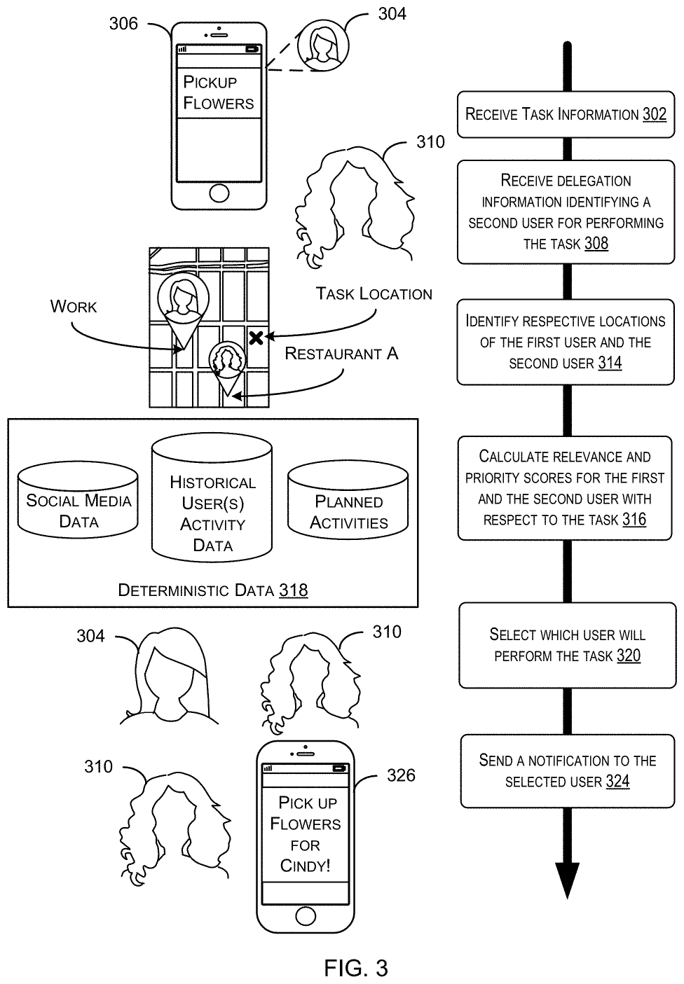

FIG. 3 is an example flow 300 for implementing task delegation techniques, in accordance with at least one embodiment. It should be appreciated that the flow 300 may include a greater number or a lesser number of operations than those depicted in FIG. 3 and that operations (e.g., the operations depicted in FIG. 3) may be performed in any suitable order. The operations of flow 300 may be performed by the user device 104 of FIG. 1 or a server computer configured to provide such functionality, or any suitable combination of the two.

The flow 300 may begin at 302, where task information may be received. As discussed above, task information may be provided by a user (e.g., the user 304) utilizing any suitable means (e.g., the user interface 200 of FIG. 2). In the example depicted, the user 304 may provide task information related to a task for picking up flowers. In some embodiments, the task information may be received via user device 306 (e.g., the user device 104 of FIG. 1). The task information may include any suitable combination of information related to the task such as a title, a description, a date and/or a time assigned to the task, a priority, reminder information (e.g., a type of reminder, a time and/or a location associated with the reminder), a task category, additional notes associated with the task, etc.

At 308, delegation information identifying a second user (e.g., individual 310) for performing the task may be received. In some embodiments, the user 304 may provide the delegation information identifying one or more people (e.g., including the second user) who are to be considered candidates for performing tasks on behalf of the user 304. In some embodiments, delegation information may be identified based on any suitable combination of deterministic data discussed above. For example, delegation candidates (including the individual 310) may be identified based on location data (e.g., people who may be nearby a location at which the task may be performed), past task performance (e.g., people who may have performed a task on behalf of the user 304 or another user in the past), social media data of the user and/or the potential delegation candidate, planned activity data of the user 304 and/or the potential delegation candidate, and the like. As a non-limiting example, if social media data is utilized, the social media data may include any suitable combination of social media posts and/or images indicating a location of the potential delegation candidate, social media events associated with user 304 and/or the potential delegation candidate, social media posts related to the user 304 for whom the task may be performed and/or the potential delegation candidate, relationships identified via a social media platform (e.g., friends of the user 304, family members of the user 304, etc.), relationships that may be inferred from social media posts (e.g., people who often comment or respond to past social media content provided by the user 304), and the like. As a specific example, the individual 310 may be identified based at least in part on delegation information received that identifies the individual 310 as a potential person to whom the task may be delegated. As another example, the individual 310 may be identified based at least in part on determining that social media data indicates that the individual 310 has a familial relationship to the user 304 (e.g., individual 310 is the adult child of the user 304).

At 312, respective locations of the first user and the second user may be identified. In some embodiments, GPS data or other location-based data provided by the user device 306 and/or a user device of the individual 310 may be utilized. Additionally, or alternatively, any suitable portion of deterministic data related to the user, a group of users, and/or the individual 310 may be utilized to determine respective locations of the user 304 and the individual 310. As a non-limiting example, the individual 310 may have “checked-in” at a location and/or social media related event. Accordingly, the location of the individual 310 may be inferred from the association with the location and/or the event as determined from the social media data associated with the individual 310. As another example, the location of the individual may be inferred based on scheduled meetings associated with the individual 310. Thus, if the individual 310 has scheduled a meeting associated with a particular location (e.g., “Dinner with Jenny at Restaurant A”), the individual 310 may be presumed to be at that location (e.g., an address/location associated with Restaurant A”) during the time frame (or approximately during the time frame) indicated in the scheduled meeting.

At 316, relevance and/or priority scores may be calculated for the first and the second user with respect to the task. Any suitable combination of task information and/or deterministic data (e.g., the deterministic data 318) associated with the user 304, the individual 310, and/or other users may be utilized to calculate such scores. A relevance score may quantify some relevance of the task with respect to a particular user. The relevance score may indicate a higher degree of relevance for situations in which the current context, or a predicted future context of the user is highly relevant to the task. By way of example, if a user is near a location associated with a task, or is likely to be near the location associated with the task within the timing window and/or deadline of the task, the relevance score for the task with respect to the user may indicate a greater degree of relevance then if the user is not within some threshold distance of the task location and/or there is no indication that the user will be near the task location within the applicable time period.

In some embodiments, a priority score may quantify a priority associated with the task and/or the user who may potentially be assigned performance of the task. A priority score may indicate a higher priority for tasks that have relatively small timing windows, approaching deadlines, and the like. In some cases, the type of task may be factored into a priority score. That is, if the task was directed to picking up diabetic medication for the user 304, the priority score for the task may be higher than if the task was directed to picking up flowers. However, a task related to picking up flowers may be assigned a higher priority score that otherwise would be calculated if, for example, the user 304 has a calendar event planned that indicates her mother's birthday is nearing (e.g., the same day, the next day, etc.) and/or a holiday (e.g., valentine's day, mother's day, etc.) was approaching. Accordingly, relevance scores may indicate whether a user's current, planned, and/or inferred activities are relevant to the task (indicating a greater likelihood that the user could/would in fact perform the task), while priority scores may indicate some urgency with respect to performing the tasks based at least in part on at least one timing consideration. The relevance scores and/or the priority scores for the user 304 and the individual 310 may be based at least in part on any suitable combination of the deterministic data 318.

At 320, the user who will be chosen to perform the task may be selected. By way of example, the respective relevance and/or priority scores of the user 304 and the individual 310 may be compared. In some embodiments, the scores may be combined and/or normalized into a composite score and/or the scores may be weighted to provide an overall score. For example, a predetermined scheme may be utilized to determine that relevance is to be given more deference then priority. Accordingly, a composite score may be higher for a first user when their current, planned, and/or inferred activities are determined to be more relevant (e.g., based at least in part on a relevance score associated with the first user and the task to be performed) than a second user whose current, planned, and/or inferred activities are determined to be less relevant (e.g., based at least in part with a relevance score associated with the second user and the task to be performed). Accordingly, a highest relevance score, priority score, and/or composite score may be selected from the user 304 and the individual 310.

As a specific example, based at least in part on deterministic data, it may be determined that the user 304 is likely to remain at work until 4:45 PM. This determination may be based at least in part on scheduling information indicating a meeting that is scheduled to end at 4:30 PM, historical user activity data indicating that the user 304 generally remains at work for, on average, 15 minutes after a last meeting of the day, or any suitable deterministic data. It may also be determined that the individual 310 (user 304's adult child) is likely to be at the Restaurant A until 4:30 PM (e.g., based at least in part on deterministic data such as a scheduled meeting and/or social media event associated with the restaurant that indicates an end time of 4:30 PM). Based at least on further analysis of the deterministic data (e.g., historical user activity information associated with the user 304 and/or the individual 310) to determine that user 304 and individual 310 are likely to end up at a common location (e.g., the residence of the user 304). This may be determined, for example, based at least in part on identifying from the deterministic data that the user 304 and the individual 310 share a residence associated with the common location, and/or the user 304 and the individual 310 have meetings and/or events (e.g., grandma's birthday) corresponding to the common location at relatively the same time period, Accordingly, individual 310 may be assigned a higher relevance score with respect to the task based at least in part on a determination that the individual 310 is closer to a location associated with the task and/or that the individual 310 is available at an earlier time than user 304. Additional examples may further based the relevance score on historical user activity data that indicates that the individual 310 has performed tasks on behalf of the user 304 that were of a same or different nature as the task at hand. For example, if the individual 310 has picked up flowers in the past for user 304, the relevance score associated with the individual 310 and the task may be higher than if the individual 310 had never picked up flowers for the user 304 in the past. These are just a few of a plethora of examples of relevance score calculations.

At 324, a notification may be sent to the selected user. The notification may be in any suitable form (e.g., text message, push notification, alarm, alert, a social media post, an email, etc.). For example, if the individual 310 was selected for the task, a notification may be provided via a user device of the individual 310 (e.g., the user device 326). In some embodiments, the notification may provide the individual 310 the option to accept delegation of the task or decline task delegation. If accepted, another notification may be provided to the user device 306 to indicate to the user 304 that the individual 310 has agreed to perform the task on behalf of the user 304. If declined, a notification may be provided at the user device 306, although in some embodiments, no notification that the individual 310 declined the task may be provided at the user device 306. By way of example, in situations in which the user 304 did not provide the delegation information, but rather the individual 310 was identified as a delegation candidate based at least in part on deterministic data, a notification that the individual 310 declined the task may not be provided at the user device 306. In embodiments in which the user 304 identified the individual 310 as a delegation candidate, a notification indicating that the individual 310 declined the task may be provided at the user device 306.

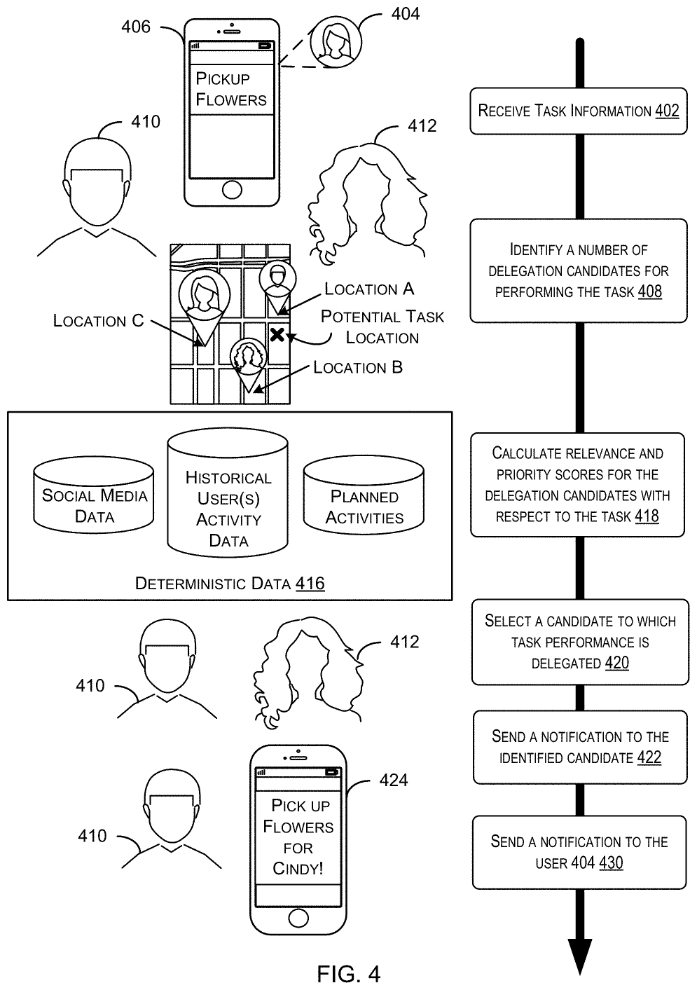

FIG. 4 is another example flow 400 for implementing task delegation techniques, in accordance with at least one embodiment. It should be appreciated that the flow 400 may include a greater number or a lesser number of operations than those depicted in FIG. 4 and that operations (e.g., the operations depicted in FIG. 4) may be performed in any suitable order. The operations of flow 400 may be performed by the user device 104 of FIG. 1 and/or a server computer configured to provide such functionality.

The flow 400 may begin at 402, where task information may be received. As discussed above, task information may be provided by a user (e.g., the user 304) utilizing any suitable means (e.g., the user interface 200 of FIG. 2). In some embodiments, the task information may be received via user device 406 (e.g., the user device 104 of FIG. 1). The task information may include any suitable combination of information related to the task such as a title, a description, a date and/or time assigned to the task, a priority, reminder information (e.g., a type of reminder, a time and/or a location associated with the reminder), a task category, additional notes associated with the task, etc.

At 408, a number of delegation candidates for performing the task may be identified. For example, delegation candidates may be identified based on any suitable combination of the deterministic data 416 (e.g., an example of any suitable combination of the data described with respect to FIG. 1). For example, delegation candidates (e.g., the individual 410 and the individual 412) may be identified based on location data associated with the respective individuals. By way of example, the individual 410 and/or the individual 412 may be currently located at a location relatively near a location at which the task may be performed. The location at which the task may be performed may be ascertained from task information provided and/or obtained when the task was initiated. For example, the task information (e.g., provided by the user 404) may indicate that the task is to be performed at a particular location (e.g., Bob's Grocery). In other embodiments, the location at which the task may be performed may be determined based at least in part on deterministic data 416.

As a simplistic example, a task associated with purchasing flowers may be performable at any suitable number of locations (e.g., grocery stores, flower shops, farmer's markets, etc.). In some embodiments, crowdsourced data (e.g., the crowdsourced activity data 106 of FIG. 1) and/or historical user activity data (e.g., the historical user activity data 108 of FIG. 1) may be analyzed to determine that users (and/or the user 404) often (e.g., over a threshold number of times) purchase flowers at particular locations (e.g., locations associated with grocery stores). In some cases, it may be determined that such tasks were performed at these locations based at least in part on identifying that users have deleted similar tasks when located at those particular locations (e.g., locations associated with a grocery store). Accordingly, the number of potential task locations (e.g., grocery stores, flower shops, farmer's markets) may be identified as potential task locations for the task based at least in part on determining that such locations are within a threshold distance of the user 404 or any suitable number of potential delegates. Accordingly, in some embodiments, the individual 410 and the individual 412 may be identified as a delegation candidate for the task based at least in part on their current locations, planned activities, social media data, or the like, that indicate that the candidate is near, or is likely to be near, a potential task location at which the task may be performed.

In some embodiments, the respective locations of delegation candidates and/or the user 404 may be determined utilizing GPS data and/or other location information as indicated with social media data 112 of FIG. 1. As a non-limiting example, the individual 410 and/or the individual 412 and/or the user 404 may be presumed to be at a particular location at a particular day/time based at least in part on an association with an event advertised within a social media platform. In another example, the location of respective delegation candidates and/or the user 404 may be inferred based at least in part on planned activity data (e.g., planned activity data 114 of FIG. 1) which may indicate that the candidate and/or user has a scheduled meeting at a particular location on a particular day and time.

Additionally or alternatively, delegation candidates may be identified based at least in part on identified and/or inferred relationships with the user 404. For example, the individual 410 may be identified as the user 404's spouse on a social media platform. The individual 412 may be identified as a “friend” or contact via a social media platform. Additionally or alternatively, the delegation candidates may be identified based at least in part on historical user activity data (e.g., the historical user activity data 108 of FIG. 1) which may indicate that the individual 410 and/or the individual 412 have performed tasks for others in the past (e.g., either performed tasks for the user 404 or for other users). Any suitable portion and/or combination of deterministic data 416 may be utilized to identify any suitable number of delegation candidates. The deterministic data 416 may include any suitable combination of crowdsourced data, historical user activity data, location data, social media data, and/or planned activities data associated with a particular user or a number of users.

In some embodiments, individual 410 may be identified as a delegate candidate based at least in part on any suitable combination of the deterministic data 318 described above that may indicate, among other things, that the individual 410 is currently at, or is like to be at location A, which is near (within a threshold distance of) the potential task location depicted, at a time at which the task may be performed. Similarly, individual 412 may be identified as a delegate candidate based at least in part on any suitable combination of the deterministic data 318 described above that may indicate, among other things, that the individual 410 is currently at, or is like to be at location B, which is near (within a threshold distance of) the potential task location depicted at a time at which the task may be performed.

Once a number of delegation candidates are identified, relevance scores and/or priority scores for the delegation candidates may be calculated at 418. Any suitable combination of task information and/or deterministic data (e.g., the deterministic data 416) associated with the user 404, the individual 410, the individual 412, and/or other users may be utilized to calculate such scores. As discussed above in connection with FIG. 4, a relevance score may quantify some relevance of the task with respect to a particular user. The relevance score may indicate a higher degree of relevance for situations in which the current context, or a predicted future context of the user is highly relevant to the task. By way of example, if a user is near a location associated with a task, or is likely to be near the location associated with the task within the timing window and/or deadline of the task, the relevance score for the task with respect to the user may indicate a greater degree of relevance then if the user is not within some threshold distance of the task location and/or there is no indication that the user will be near the task location within the applicable time period. In the example depicted in FIG. 4, the individual 410 may be assigned a higher relevance score that the individual 412 based at least in part on a determination that location A (associated with the individual 410's current, inferred, or expected location) is closer to a potential task location than location B (associated with the individual 412's current, inferred, or expected location).

In some embodiments, a priority score may quantify a priority associated with the task and/or the individual who may potentially be delegated performance of the task. A priority score may indicate a higher priority for tasks that have relatively small timing windows, that are approaching deadlines, and/or for tasks that have some higher degree of importance. For example, a task that has a deadline occurring in 15 minutes may be assigned a higher priority than a task that has a deadline occurring in two days. As another example, a task related to purchasing airline tickets may be assigned a higher priority score than purchasing flowers in some situations (e.g., when a trip is scheduled for which the airline tickets likely relate), but a task for purchasing flowers may be assigned a higher priority score if it is determined that purchasing flowers may have nearer deadline than required for the task of purchasing the airline tickets.

Accordingly, relevance scores may indicate whether a candidates current, planned, and/or inferred activities are relevant to the task (indicating a greater likelihood that the user could/would in fact perform the task), while priority scores may indicate some urgency with respect to performing the tasks based at least in part on at least one timing consideration (e.g., the candidates schedule, a deadline associated with the task, etc.). The relevance scores and/or the priority scores for the individual 410 and/or the individual 412 may be based at least in part on any suitable combination of the deterministic data 416.

At 420, a candidate may be selected to which task performance may be delegated. By way of example, the respective relevance and/or priority scores of the individual 410 and the individual 412 may be compared. In some embodiments, the scores may be combined and/or normalized into a composite score and/or the scores may be weighted to provide an overall score. For example, a predetermined scheme may be utilized to determine that relevance is to be given more deference than priority. Accordingly, a composite score may be higher for a candidate when their current, planned, and/or inferred activities are determined to be more relevant (e.g., based at least in part on a relevance score associated with the candidate and the task to be performed) than another candidate whose current, planned, and/or inferred activities are determined to be less relevant (e.g., based at least in part with a relevance score associated with the other candidate and the task to be performed). Accordingly, a highest relevance score, priority score, and/or composite score may be determined and a corresponding individual may be selected to which task performance may be delegated.

As a specific example of For example, based at least in part on deterministic data, it may be determined that the user 404 is likely to remain at work until 4:45 PM. This determination may be based at least in part on scheduling information indicating a meeting that is scheduled to conclude at 4:30 PM, historical user activity data indicating that the user 404 generally remains at work for, on average, 15 minutes after a last meeting of the day, or any suitable deterministic data. It may also be determined that the individual 410 (user 404's friend and coworker) is likely to be at location A until 3:30 PM (e.g., based at least in part on deterministic data such as a scheduled meeting and/or social media event associated with location A that indicates an end time of 3:30 PM). Based at least on further analysis of the deterministic data (e.g., historical user activity information associated with the user 404 and/or the individual 410) to determine that user 404 and individual 410 are likely to end up at a common location (e.g., a work location associated with location C). This may be determined, for example, based at least in part on identifying from the deterministic data that the user 404 and the individual 410 typically spend similar days/times at a common location (e.g., location C), and/or the user 404 and the individual 410 have meetings and/or events corresponding to the common location at relatively the same time period.

It may also be determined that the individual 412 (user 404's adult child) is likely to be at the Location B until 4:30 PM (e.g., based at least in part on deterministic data such as a scheduled meeting and/or social media event associated with location B that indicates an end time of 4:30 PM, a text message to user 404, or the like). Based at least on further analysis of the deterministic data (e.g., historical user activity information associated with the user 404 and/or the individual 412) to determine that user 404 and individual 412 have a familial relationship. This may be determined, for example, based at least in part on identifying from the deterministic data that the user 404 and the individual 412 share a residence, and/or the user 404 and the individual 412 have meetings and/or events at a common location over a threshold number of times, and/or social media data indicating the familial relationship, and the like. Individual 410 and individual 412 may be individually assigned a relevance and priority score for performing the task on behalf of the user 404. In some cases, the individual 410 may be assigned a higher relevance score with respect to the task based at least in part on a determination that the individual 410 is within a threshold distance to a location associated with the task (and in this case, closer to the task location than the individual 412). Additionally, a priority score for the individual 410 may be higher than a priority score assigned to the individual 412 based at least in part on determining that the individual 412 is available at a time (or before a deadline) associated with the task, and/or that the individual 410 is likely going to see user 404 within a threshold period of time (and in this case, earlier than the individual 412). This example is just one example of the plethora of ways in which a relevance score and/or a priority score may be calculated. In some embodiments, the individual 410 may be selected as the task delegate based at least in part on the higher relevance and/or priority score.

At 422, a notification may be sent to the selected candidate (e.g., individual 410). The notification may be in any suitable form (e.g., text message, push notification, alarm, alert, a social media post, an email, etc.). For example, if the individual 410 was selected for the task, a notification may be provided via a user device of the individual 410 (e.g., the user device 424). In some embodiments, the notification may provide the individual 410 the option to accept delegation of the task or decline task delegation. If accepted, another notification may be provided to the user device 406 at 430 that may indicate to the user 404 that the individual 410 has been delegated to perform the task and has confirmed that he will do so. If declined, a notification may, or may not, be provided at the user device 406.

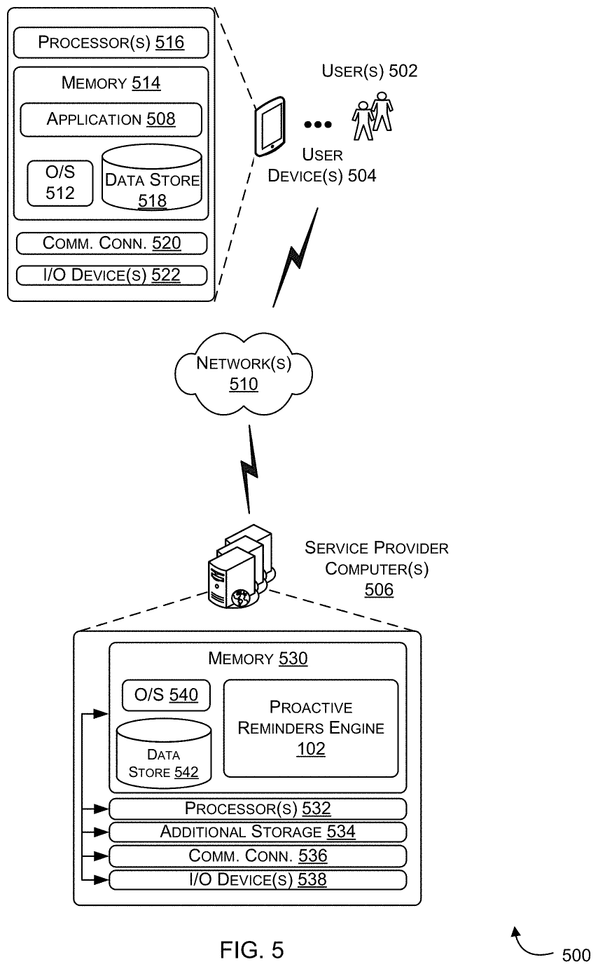

FIG. 5 is an example architecture for a system 500 for providing a proactive reminders utilizing a proactive reminders engine, in accordance with at least one embodiment. In system 500, one or more users 502 may utilize a user device (e.g., user device(s) 504, which are individually examples of the user device 104 of FIG. 1) to interact with the proactive reminders engine 102 and/or to provide information to or receive information from the proactive reminders engine 102. In some embodiments, information exchanged between the user device(s) 504 and the service provider computer(s) 506 may utilize network(s) 510. Although depicted as part of the service provider computer(s) 506, the proactive reminders engine 102 may be operated in whole, or in part, by a user device (e.g., as part of application 508). For example, the user may access a user interface accessible through an application 508 running on the user device(s) 504. In some embodiments, the application 508 operating on the user device(s) 504 may be hosted, managed, and/or provided by a computing resources service or service provider, such as by utilizing one or more service provider computer(s) 506.

In some examples, the network(s) 510 may include any one or a combination of many different types of networks, such as cable networks, the Internet, wireless networks, cellular networks, and other private and/or public networks. While the illustrated example represents the users 502 accessing application functionality over the network(s) 510, the described techniques may equally apply in instances where the users 502 interact with the service provider computer(s) 506 via the one or more user device(s) 504 over a landline phone, via a kiosk, or in any other suitable manner. It should be appreciated that the described techniques may apply in other client/server arrangements, as well as in non-client/server arrangements (e.g., locally stored applications, etc.).

As described above, the application 508 may be any suitable application which task information may be obtained. In some embodiments, the application 508 may be configured to render the user interface 200 of FIG. 2 on a display of the user device(s) 504. Examples of the application 508 may include text messaging applications, web browsers, list management applications, task-related applications, calendar and/or scheduling applications, and the like. In some embodiments, reminders may be provided by and/or through the application 508 and/or reminders may be provided as push notifications, alarms, alerts, email messages, text messages, or any suitable electronic means either provided by the application 508, another application operating on the user device(s) 504, and/or as functionality of the operating system 512 of the user device(s) 504.

The service provider computer(s) 506, perhaps arranged in a cluster of servers or as a server farm, may host the application 508 operating on the user device(s) 504 and/or cloud-based software services. Other server architectures may also be used to host the application 508 and/or cloud-based software services. The application 508 operating on the user device(s) 504 may be capable of handling requests from the users 502 and serving, in response, various user interfaces that can be rendered at the user device(s) 504 (e.g., the user interface 200 of FIG. 2). The application 508 operating on the user device(s) 504 can present any suitable type of website that supports user interaction.

The user device(s) 504 may be any suitable type of computing device such as, but not limited to, a mobile phone, a hand-held scanner, a touch screen device, a smartphone, a personal digital assistant (PDA), a laptop computer, a desktop computer, a thin-client device, a tablet PC, an electronic book (e-book) reader, etc. In some examples, the user device(s) 504 may be in communication with the service provider computer(s) 506 via the network(s) 510, or via other network connections.

In one illustrative configuration, the user device(s) 504 may include at least one memory 514 and one or more processing units (or processor(s)) 516. The processor(s) 516 may be implemented as appropriate in hardware, computer-executable instructions, firmware, or combinations thereof. Computer-executable instruction or firmware implementations of the processor(s) 516 may include computer-executable or machine-executable instructions written in any suitable programming language to perform the various functions described.

The user device(s) 504 may also contain communications connection(s) 520 that allow the user device(s) 504 to communicate with a stored database, another computing device or server, user terminals and/or other devices on the network(s) 510. The user device(s) 504 may also include I/O device(s) 522, such as a keyboard, a mouse, a pen, a voice input device, a touch input device, a display, speakers, a printer, etc.

The memory 514 may store program instructions that are loadable and executable on the processor(s) 516, as well as data generated during the execution of these programs. Depending on the configuration and type of user computing device, the memory 514 may be volatile (such as random access memory (RAM)) and/or non-volatile (such as read-only memory (ROM), flash memory, etc.). The user device(s) 504 may also include additional removable storage and/or non-removable storage including, but not limited to, magnetic storage, optical disks, and/or tape storage. The disk drives and their associated computer-readable media may provide non-volatile storage of computer-readable instructions, data structures, program modules, and other data for the computing devices. In some implementations, the memory 514 may include multiple different types of memory, such as static random access memory (SRAM), dynamic random access memory (DRAM), or ROM.

Turning to the contents of the memory 514 in more detail, the memory 514 may include an operating system 512 and one or more application programs, modules, or services for implementing the features disclosed herein, such as via the application 508 (e.g., a task-related application). The application 508 may be configured to receive, store, and/or display a network page or other interface for interacting with the service provider computer(s) 506 and/or the proactive reminders engine 102. Additionally, the memory 514 may store access credentials and/or other user information such as, but not limited to, user IDs, passwords, and/or other user information. In some examples, the user information may include information for authenticating an account access request such as, but not limited to, a device ID, a cookie, an IP address, a location, or the like. The memory 514 may be configured with one or more data stores such as data store 518. In some embodiments, data store 518 may be configured to store any suitable portions and/or combinations of various deterministic data (e.g., crowdsourced activity data 106, historical user activity data 108, location data 110, social media data 112, and/or planned activity data 114 of FIG. 1).

In some aspects, the service provider computer(s) 506 may also be any suitable type of computing devices such as, but not limited to, a mobile phone, a smart phone, a personal digital assistant (PDA), a laptop computer, a desktop computer, a server computer, a thin-client device, a tablet PC, etc. Additionally, it should be noted that in some embodiments, the service provider computer(s) 506 are executed by one more virtual machines implemented in a hosted computing environment. The hosted computing environment may include one or more rapidly provisioned and released computing resources, which computing resources may include computing, networking and/or storage devices. A hosted computing environment may also be referred to as a cloud-computing environment. In some examples, the service provider computer(s) 506 may be in communication with the user device(s) 504 and/or other service providers via the network(s) 510 or via other network connections. The service provider computer(s) 506 may include one or more servers, perhaps arranged in a cluster, as a server farm, or as individual servers not associated with one another. These servers may be configured to implement the functionality described herein as part of an integrated, distributed computing environment.

In one illustrative configuration, the service provider computer(s) 506 may include at least one memory 530 and one or more processing units (or processor(s)) 532. The processor(s) 532 may be implemented as appropriate in hardware, computer-executable instructions, firmware, or combinations thereof. Computer-executable instruction or firmware implementations of the processor(s) 532 may include computer-executable or machine-executable instructions written in any suitable programming language to perform the various functions described.

The memory 530 may store program instructions that are loadable and executable on the processor(s) 532, as well as data generated during the execution of these programs. Depending on the configuration and type of service provider computer(s) 506, the memory 530 may be volatile (such as RAM) and/or non-volatile (such as ROM, flash memory, etc.). The service provider computer(s) 506 or servers may also include additional storage 534, which may include removable storage and/or non-removable storage. The additional storage 534 may include, but is not limited to, magnetic storage, optical disks and/or tape storage. The disk drives and their associated computer-readable media may provide non-volatile storage of computer-readable instructions, data structures, program modules, and other data for the computing devices. In some implementations, the memory 530 may include multiple different types of memory, such as SRAM, DRAM, or ROM.

The memory 530, the additional storage 534, both removable and non-removable, are all examples of computer-readable storage media. For example, computer-readable storage media may include volatile or non-volatile, removable or non-removable media implemented in any method or technology for storage of information such as computer-readable instructions, data structures, program modules, or other data. The memory 530 and the additional storage 534 are all examples of computer storage media. Additional types of computer storage media that may be present in the service provider computer(s) 506 may include, but are not limited to, PRAM, SRAM, DRAM, RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by the service provider computer(s) 506. Combinations of any of the above should also be included within the scope of computer-readable media.

Alternatively, computer-readable communication media may include computer-readable instructions, program modules, or other data transmitted within a data signal, such as a carrier wave, or other transmission. However, as used herein, computer-readable storage media does not include computer-readable communication media.

The service provider computer(s) 506 may also contain communications connection(s) 536 that allow the service provider computer(s) 506 to communicate with a stored database, another computing device or server, user terminals and/or other devices on the network(s) 510. The service provider computer(s) 506 may also include I/O device(s) 538, such as a keyboard, a mouse, a pen, a voice input device, a touch input device, a display, speakers, a printer, etc.

Turning to the contents of the memory 530 in more detail, the memory 530 may include an operating system 540, one or more data stores 542, and/or one or more application programs, modules, or services for implementing the features disclosed herein, such as the features provided by the proactive reminders engine 102. In some embodiments, one or more data stores 542 may be configured to store any suitable portions and/or combinations of various deterministic data (e.g., crowdsourced activity data 106, historical user activity data 108, location data 110, social media data 112, and/or planned activity data 114 of FIG. 1).

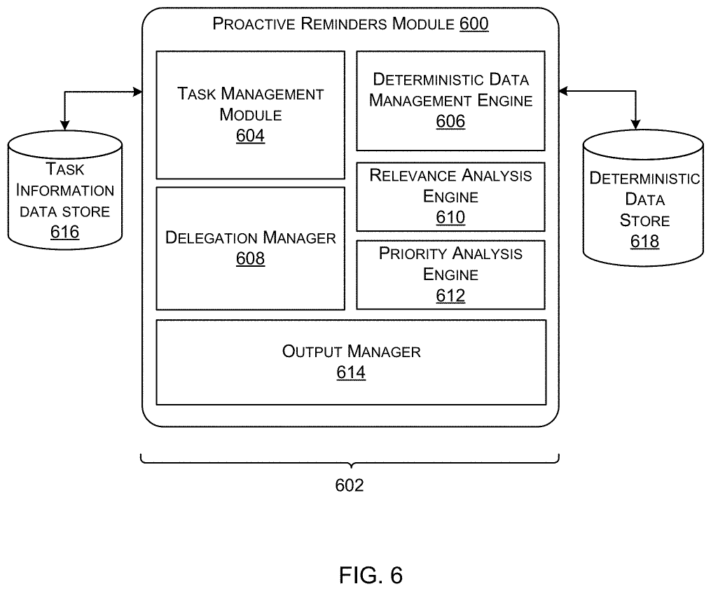

FIG. 6 illustrates in greater detail the components of an example proactive reminders engine, in accordance with at least one embodiment. Proactive reminders engine 600 may be an example of the proactive reminders engine 102 of FIGS. 1 and 5. As shown, the example embodiment includes a number of modules 602 including, but not limited to a task management module 604, a deterministic data management engine 606, a delegation manager 608, a relevance analysis engine 610, a priority analysis engine 612, and an output manager 614. It should be appreciated that each module of FIG. 6 may be executed on a single computer, and or each component, or sets of components may be executed on separate computers. The modules 602 may be communicatively coupled to at suitable number of data stores (e.g., the task information data store 616 and/or the deterministic data store 618) such that data may be exchanged between the modules/engines and the data stores. It should be appreciated that any combination of the data stores 616 and 618 may be provided by the data store 518 and/or 542 of FIG. 5.

In at least one embodiment, the task management module 604 may be configured to receive and/or obtain task information. Task information may include parameters for performance of the task. By way of example, task parameters (sometimes referred to as “task information”) may include a title, a description, a date and/or a time assigned to the task, a priority, reminder information (e.g., a type of reminder, a time and/or a location associated with the reminder), a task category, additional notes associated with the task, or the like) may be optionally provided at the user interface. The task management module 604 may be configured to receive task parameters from a user device (e.g., the user device 104 of FIG. 1, the user device(s) 504 of FIG. 5, etc.). In some embodiments, the task parameters may be provided by a user directly and/or indirectly. That is, in some cases, the user may provide task parameters via a user interface (e.g., the user interface 200 of FIG. 2). In some embodiments, some portion (or all) of the task parameters may be obtained by the task management module 604 by analyzing any suitable information provided by the phone, or ascertainable by the task management module 604. By way of example, the task management module 604 may be configured to receive and/or access information regarding voice commands, text messages, emails, notes, lists, application data, and the like, to determine that a task is to be initiated and the particular task parameters for the task. In some embodiments, the task management module 604 may utilize any suitable combination of the deterministic data (e.g., stored in the deterministic data store 618) to determine some portion of the parameters for the task. For example, deterministic data associated with the user and/or a group of users may be utilized to determine a timing window, a deadline, a location, or any suitable parameter for the task. One task parameters is received, obtained, and/or determined the task management module 604 may store such parameters in a storage location such as the task information data store 616.

In at least one embodiment, the deterministic data management engine 606 may be configured to receive and/or obtain deterministic data from any suitable number of sources and store such data a suitable location such as the deterministic data store 618. By way of example, the deterministic data management engine 606 may be configured to receive any suitable data such as the crowdsourced activity data 106, the historical user activity data 108, the location data 110, the social media data 112, and/or the planned activity data 114, from any suitable source (e.g., the user device 104, a server computer, etc.). Once received, the deterministic data may be stored and maintained by the deterministic data management engine 606. In some embodiments, the deterministic data management engine 606 may be configured to monitor and/or request deterministic data from any suitable source at any suitable time (e.g., periodically, on set days/times, etc.) in order to maintain relatively current deterministic data on any suitable number of users.

In at least one embodiment, the delegation manager 608 may be configured to identify any suitable number of potential delegation candidates for a particular task. The delegation manager 608 may access any suitable task parameters for the task (e.g., stored in the task information data store 616) and/or any suitable deterministic data of a user and/or a group of users (e.g., stored in the deterministic data store 618). In some embodiments, the delegation manager 608 may receive/obtain task parameters which relate to one or more specified delegation candidates for the task. In some embodiments, the delegation manager 608 may identify any suitable number of delegation candidates based at least in part on analyzing deterministic data for one or more users. The delegation manager 608 may be configured to provide the identities of the delegation candidates (or at least some of the delegation candidates) and/or the user (who may also be considered as a candidate for the task) to the relevance analysis engine 610 and/or the priority analysis engine 612 for scoring. The delegation manager 608 may further be configured to receive relevance scores and priority scores assigned to the delegation candidates (and/or the user) from the relevance analysis engine 610 and the priority analysis engine 612, respectively. In some examples, the delegation manager 608 may receive a composite score that combines a relevance score and a priority score according to some predetermined scheme. In some embodiments, the delegation manager 608 may utilize the relevance scores, the priority scores, and/or the composite scores to select a particular delegation candidate (and/or the user) by whom the task may be performed. In some embodiments, the delegation manager 608 may provide information to the output manager 614 to cause the output manager 614 to provide a notification and/or a proactive reminder to the select task performer (e.g., the user or one of the delegation candidates).

In at least one embodiment, the relevance analysis engine 610 may be configured to calculate and assign relevance scores with respect to a particular user and a particular task. As a non-limiting example, the relevance analysis engine 610 may calculate a relevance score for the user and/or for any suitable number of delegation candidates. A relevance score may quantify some relevance of the task with respect to a particular user. The relevance score may indicate a higher degree of relevance for situations in which the current context, or a predicted future context of the user is highly relevant to the task (e.g., as indicated by the deterministic data and the task parameters for the task). By way of example, if a user is near a location associated with a task (or a potential task performance location), or is likely to be near such a location within the timing window and/or deadline of the task, the relevance score for the task with respect to the user may indicate a greater degree of relevance then if the user is not within some threshold distance of the task location and/or there is no indication that the user will be near the task location (a potential task location) within the applicable time period. The relevance score may be calculated according to a predetermined scheme. Relevance scores may indicate whether a user's current, planned, and/or inferred activities are relevant to the task (indicating a greater likelihood that the user could/would in fact perform the task). The relevance analysis engine 610 may be further configured to provide the calculated relevance score(s) to any suitable module of the modules 602.

In at least one embodiment, the priority analysis engine 612 may be configured to calculate and assign relevance scores with respect to a particular user and a particular task. In some embodiments, a priority score may quantify a priority associated with the task and/or the user who may potentially be assigned performance of the task. A priority score may indicate a higher priority for tasks that have relatively small timing windows, approaching deadlines, and the like. In some cases, the type of task may be factored into a priority score. That is, if the task was directed to an activity with some degree of urgency and/or inherent importance, the priority score for the task may be higher than if the task was directed to an activity that could be easily accomplished and/or was less important to some degree. The priority score(s) may be calculated based at least in part on any suitable combination of the deterministic data (e.g., stored in the deterministic data store 618). By way of example, crowdsourced activity data, historical user activity data, location data, social media data, and/or planned activities data (each associated with one or more users) may be utilized to calculate a priority score quantifying the priority of the task with respect to a particular user. Although depicted as separate modules, the relevance analysis engine 610 and the priority analysis engine 612 may be implemented as a single module (or part of another module) to calculate both relevance scores and priority scores. In some embodiments, the combined module, the relevance analysis engine 610, and/or the priority analysis engine 612 may be configured to calculate a composite score which combines aspects of a relevance score and a priority score into a single composite score and may provide any suitable combinations of the relevance score, the priority score, and/or the composite score to any suitable module of the modules 602.

In at least one embodiment, the output manager 614 may be configured to provide delegation notifications and/or proactive reminders to any suitable user device. In some examples, the output manager 614 may be configured to provide text messages, emails, push notifications, alerts, alarms, audio speech, or the like at the user device. By way of example, the output manager may be configured to receive information from the delegation manager 608 that indicates that a particular user is to be provided a notification (and/or a proactive reminder) via a push notification. The output manager 614 may format the notification and/or proactive reminder according to a predetermined scheme and may execute operations that cause the push notification to be provided at the user device. As used herein, a “notification” may relate to information regarding a task for which the reader was previously unaware (e.g., as when a delegation candidate receives information that indicates a request to perform a task on behalf of another user, when a task was generated via means that did not include the user manually initiating the task, etc.). A “proactive reminder” is intended to refer to the presentation of information in any suitable form for a task for which the recipient was previously aware (e.g., as when a user manually initiated the task himself).

It should be appreciated that in any given scenario, any suitable number and/or combination of notifications and/or proactive reminders may be provided. For example, if a proactive reminder appears to have been ineffective, and it is determined (e.g., by the task management module 604) that the task has not been completed, one or more subsequent proactive reminders may be provided at the user device.

Further, it is contemplated that supervised and/or unsupervised machine learning techniques may be utilized by any suitable module discussed herein in order to determine a likelihood that a user is to be at a certain location, a likelihood that a user will perform a particular activity (and/or the timing and/or the manner in which they may perform the activity), a likelihood that a notification and/or proactive reminder will be successful in bringing about the performance of the task by a particular user, to calculate relevance/priority/composite scores, to identify a type of notification and/or proactive reminder to be provided to a particular user, and the like. Such supervised and/or unsupervised machine learning techniques may utilize any suitable combination of task information and/or deterministic data in order to output any suitable combination of classification for a task, a type of notification and/or proactive reminder to be provided to a particular user, and/or at least one value that indicates a likelihood that a particular scenario will be true (e.g., 90% probable that the user will be at location A around 4:00 PM, 50% probability that the user will see a particular individual on Tuesday, etc.).

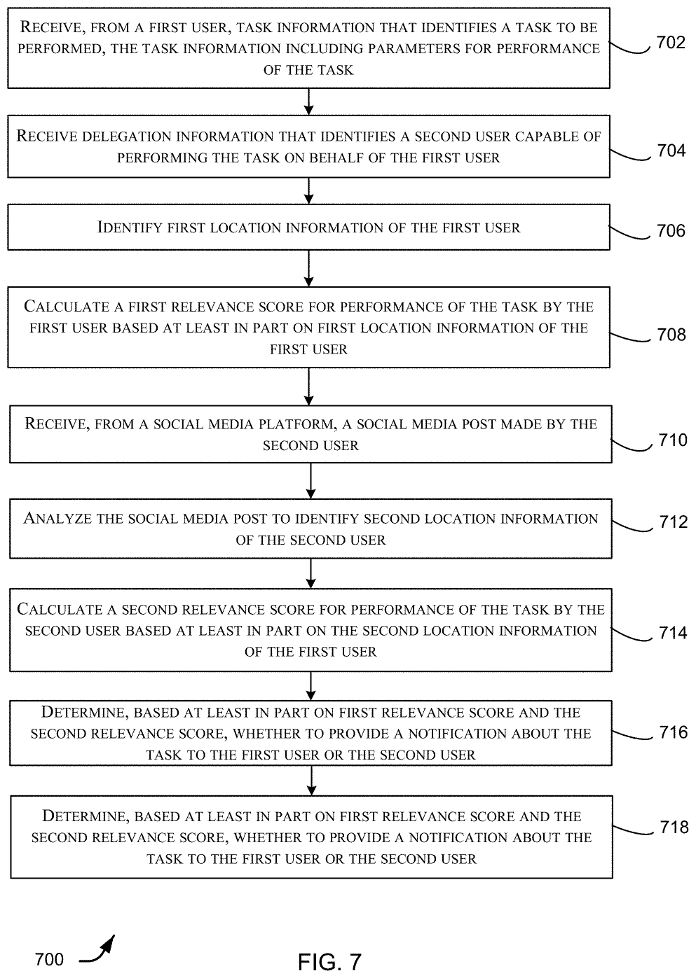

FIG. 7 is a flowchart illustrating an example method 700 for implementing aspects of task delegation, in accordance with at least one embodiment. The method 700 may be performed by one or more components of the proactive reminders engine 600 of FIG. 6. The method 700 may performed in any suitable order. It should be appreciated that the method 700 may include a greater number or a lesser number of operations than those depicted in FIG. 7 and that the operations may be performed in any suitable order.

The method may begin at 702, where task information is received (e.g., by the task management module 604 of FIG. 6) from a first user. In some embodiments, the task information identifies a task to be performed and may include parameters for performance of the task.

At 704, delegation information may be received (e.g., by the delegation manager 608 of FIG. 6) that identifies a second user capable of performing the task on behalf of the first user.

At 706, first location information of the first user may be identified. For example, location information may be received as GPS coordinates or another format of positioning data. In some examples, location information may be identified via any suitable portion of deterministic data associated with the first user. By way of example, the user may be associated with an event advertised on a social media platform that is associated with a particular location. Accordingly, the user's location may be inferred as being at the particular location during the course of the event proceedings.

At 708, a first relevance score for performance of the task by the first user may be calculated (e.g., by the relevance analysis engine 610). The relevance score may be based at least in part on first location information of the first user.

At 710, a social media post made by the second user may be received (e.g., by the deterministic data management engine 606 of FIG. 6) from a social media platform. The social media post may identify other users, include images of a location, include text identifying a location, include event references associated with an event advertised on a social media platform, and the like.

At 712, the social media post may be analyzed (e.g., by the delegation manager 608) to identify second location information of the second user.

At 714, a second relevance score for performance of the task by the second user may be calculated (e.g., by the relevance analysis engine 610). In some embodiments, the second relevance score may be calculated based at least in part on the second location information of the second user.

At 716, a determination may be made (e.g., by the delegation manager 608) as to whether to provide a notification about the task to the first user or the second user. The determination may be based at least in part on first relevance score and the second relevance score.

At 718, a notification (and/or a proactive reminder) about the task may be provided (e.g., by the output manager 614 of FIG. 6) to one of the first user or the second user based at least in part on the determination.

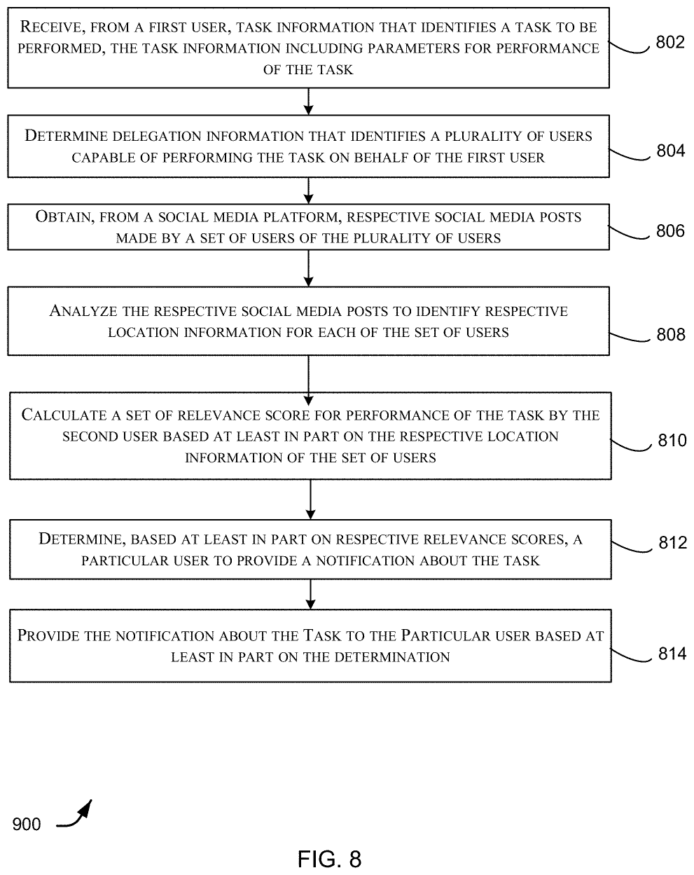

FIG. 8 is a flowchart illustrating another example method 800 for providing a proactive reminder (e.g., a notification), in accordance with at least one embodiment. The method 800 may be performed by one or more components of the proactive reminders engine 600 of FIG. 6. The method 800 may performed in any suitable order. It should be appreciated that the method 800 may include a greater number or a lesser number of operations than that depicted in FIG. 8 and that the operations may be performed in any suitable order.

The method may begin at 802, where task information may be received (e.g., by the task management module 604 of FIG. 6) from a first user. The task information may identify a task to be performed and may include parameters for performance of the task.

At 804, delegation information may be determined (e.g., by the delegation manager 608) that identifies a plurality of users capable of performing the task on behalf of the first user. As discussed above, delegation candidates (e.g., the plurality of users) may be identified based at least in part on any suitable portion of deterministic data including crowdsourced activity data, historical user activity data, location data, social media data, and/or planned activities data.

At 806, respective social media posts made by a set of users of the plurality of users capable of performing the task on behalf of the first user may be obtained (e.g., by the deterministic data management engine 606 and/or the delegation manager 608 of FIG. 6) from a social media platform.

At 808, respective social media posts may be analyzed (e.g., by the delegation manager 608) to identify respective location information for each of the set of users. The social media posts may individually identify other users, include images of a location, include text identifying a location, include event references (related to a particular location) associated with an event advertised on a social media platform, and the like. As a non-limiting example, each user's location may be inferred as being at a particular location associated with an event advertised on a social media platform for a time period associated with the event.

At 810, a set of relevance scores for performance of the task by the set of users may be calculated (e.g., by the relevance analysis engine 610). The set of relevance scores being calculated based at least in part on the respective location information of the set of users.

At 812, a particular user to provide a notification about the task may be determined (e.g., by the delegation manager 608) based at least in part on respective relevance scores.

At 814, a notification (and/or a proactive reminder) about the task may be provided (e.g., by the output manager 614 of FIG. 6) to the particular user based at least in part on the determination.

As described above, one aspect of the present technology is the gathering and use of data available from various sources to provide proactive reminders and/or notifications. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, date of birth, or any other identifying or personal information.

The present disclosure recognizes that the use of such personal information data, in the present technology, can be used to the benefit of users. For example, the personal information data can be used to deliver proactive reminders and/or notifications. Accordingly, use of such personal information data enables users to receive reminders and/or notifications at a time and in a manner that may facilitate completion of a task. Thus, the personal information data discussed herein may aid the user in ensuring that a task is generated and/or the user is prompted to complete the task according the that particular user's schedule and daily activities.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of proactive reminder and/or notification services, the present technology can be configured to allow users to select to “opt in” or “opt out” of participation in the collection of personal information data (or some portion of their personal information data) during registration for services or anytime thereafter. In another example, users can select not to provide personal information data for the purposes of receiving proactive reminders and/or notifications. In yet another example, users can select to limit the length of time personal information data is maintained or entirely prohibit the user of proactive reminders and/or notifications. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, proactive reminders and/or notifications may be generated and/or delivered by inferring preferences based on non-personal information data or a bare minimum amount of personal information, such as the content being requested by the device associated with a user, other non-personal information available to the proactive reminders engine, or publicly available information.

The specification and drawings are to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions and equivalents falling within the spirit and scope of the invention, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known to the inventors for carrying out the invention. Variations of those preferred embodiments may become apparent to those of ordinary skill in the art upon reading the foregoing description. The inventors expect skilled artisans to employ such variations as appropriate and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All references, including publications, patent applications and patents, cited herein are hereby incorporated by reference to the same extent as if each reference were individually and specifically indicated to be incorporated by reference and were set forth in its entirety herein.

What is claimed is:

1. A method, comprising:
receiving, from a first user, task information that identifies a task to be performed, the task information including parameters for performance of the task;
receiving delegation information that identifies a second user capable of performing the task on behalf of the first user;
identifying first location information of the first user;
calculating a first relevance score for performance of the task by the first user based at least in part on first location information of the first user;
receiving, from a social media platform, a social media post made by the second user;
analyzing the social media post to identify second location information of the second user;
calculating a second relevance score for performance of the task by the second user based at least in part on the second location information of the second user;
determining, based at least in part on first relevance score and the second relevance score, whether to provide a notification about the task to the first user or the second user; and
providing the notification about the task to one of the first user or the second user based at least in part on the determination.

2. The method of claim 1, further comprising:
obtaining first scheduling information for the first user, wherein calculating the first relevance score is further based at least in part on the first scheduling information;
obtaining second scheduling information for the second user, wherein calculating the second relevance score is further based at least in part on the second scheduling information.

3. The method of claim 2, further comprising:
calculating a first priority score for performance of the task by the first user; and
calculating a second priority score for performance of the task by the second user, wherein determining whether to provide the notification about the task to the first user or the second user is further based at least in part on the first priority score and the second priority score.

4. The method of claim 3, further comprising:
obtaining first historical activity information related to previously performed activities of the first user; and
obtaining second historical activity information related to previously performed activities of the second user, wherein determining whether to provide the notification about the task to the first user or the second user is further based at least in part on the first historical activity information and the second historical activity information.

5. The method of claim 1, wherein first relevance score is calculated based at least in part on the parameters for performance of the task and a distance of the first user from a location associated with the task.

6. An electronic device, comprising:
a memory; and
one or more processors in communication with the memory, the one or more processors configured to:
receive, from a first user, task information that identifies a task to be performed, the task information including parameters for performance of the task;
determine delegation information that identifies a plurality of users capable of performing the task on behalf of the first user;
obtain, from a social media platform, respective social media posts made by a set of users of the plurality of users capable of performing the task on behalf of the first user;
analyze the respective social media posts to identify respective location information for each of the set of users;
calculate a set of relevance score for performance of the task by the set of users based at least in part on the respective location information of the set of users;
determine, based at least in part on respective relevance scores, a particular user to provide a notification about the task; and
provide the notification about the task to the particular user based at least in part on the determination.

7. The electronic device of claim 6, wherein the one or more processors are further configured to:
calculate a priority score associated with the particular user and the task; and
determine when to provide the notification about the task to the particular user based at least in part a relevance score associated with the particular user and the priority score for the task.

8. The electronic device of claim 7, wherein the priority score is calculated based at least in part on a deadline associated with the task, a location of the particular user, a schedule associated with the particular user, historical activity data associated with the particular user, and historical activity data associated with a group of users.

9. The electronic device of claim 8, wherein the priority score quantifies a timeliness factor associated with the task and the particular user.

10. The electronic device of claim 6, wherein the one or more processors are further configured to:
obtain previously-executed task information associated with previous tasks associated with the first user; and
identify particular users from the previously-executed task information, wherein the particular users are identified as performing at least one previous task on behalf of the first user, wherein the particular user is determined from the set of users based at least in part on the particular user being identified as being one of the particular users that has performed at least one previous task on behalf of the first user.

11. The electronic device of claim 6, wherein the one or more processors are further configured to identify, independent of specification by the first user, that the notification for the task is to be provided to the particular user, wherein the particular user is determined independent of specification by the first user.

12. The electronic device of claim 6, wherein the one or more processors are further configured to:
receive, from the particular user, indication that the particular user has agreed to perform the task on behalf of the first user; and
provide an indication to the first user that the particular user has agreed to perform the task on behalf of the first user.

13. The electronic device of claim 6, wherein the one or more processors are further configured to receive, from the plurality of users, respective indications that the plurality of users agree to receive notifications for tasks associated with the first user, wherein the delegation information that identifies a plurality of users capable of performing the task on behalf of the first user is determined based at least in part on the respective indications being received.

14. A computer-readable storage medium storing computer-executable instructions that, when executed by one or more processors, configure the one or more processors to perform operations comprising:
receiving, from a first user, task information that identifies a task to be performed, the task information including parameters for performance of the task;
receiving delegation information that identifies a second user capable of performing the task on behalf of the first user;
identifying first location information of the first user;
calculating a first relevance score for performance of the task by the first user based at least in part on first location information of the first user;
receiving, from a social media platform, a social media post made by the second user;
analyzing the social media post to identify second location information of the second user;
calculating a second relevance score for performance of the task by the second user based at least in part on the second location information of the first user;
determining, based at least in part on first relevance score and the second relevance score, whether to provide a notification about the task to the first user or the second user; and
providing the notification about the task to one of the first user or the second user based at least in part on the determination.

15. The computer-readable storage medium of claim 14, wherein the first relevance score quantifies a similarity between a location associated with a task and the first location information of the first user.

16. The computer-readable storage medium of claim 14, wherein the first relevance score is further based at least in part on a past activity conducted by the first user.

17. The computer-readable storage medium of claim 14, wherein the first relevance score is further based at least in part on past activities conducted by a group of users.

18. The computer-readable storage medium of claim 17, wherein the group of users include at least one user that has conducted a task that is similar to the task to be performed.

19. The computer-readable storage medium of claim 14, wherein the first relevance score is further based at least in part on a schedule associated with the first user.

20. The computer-readable storage medium of claim 14, wherein the one or more processors are further configured to perform the operations comprising:
calculating a first priority score for the first user, the first priority score quantifying an urgency for performing the task by the first user; and
calculating a second priority score for the second user, the second priority score quantifying the urgency for performing the task by the second user, wherein determining whether to provide the notification about the task to the first user or the second user is further based at least in part on the first priority score and the second priority score.
